(19) United States
(12) Patent Application Publication
(10) Pub. No.: US 2009/0094026 A1
(43) Pub. Date: Apr. 9, 2009

(54) METHOD OF DETERMINING AN ESTIMATED FRAME ENERGY OF A COMMUNICATION

(76) Inventors: Binshi Cao, Bridgewater, NJ (US); Doh-Suk Kim, Basking Ridge, NJ (US); Ahmed A. Tarraf, Bayonne, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 11/866,448

(22) Filed: Oct. 3, 2007

(51) Int. Cl. G10L 19/12

(52) U.S. Cl. 704/223

(57) ABSTRACT

A method of processing a communication includes determining an estimated excitation energy component of a subframe of a coded frame. A filter energy component of the subframe is also estimated. Determining an estimated energy of the subframe is based upon the estimated excitation energy component and the estimated filter energy component. This technique allows for estimating frame energy of a communication such as a voice communication without having to fully decode the communication.

### FIELD OF THE INVENTION

This invention generally relates to communication. More particularly, this invention relates to determining an estimated frame energy of a communication.

### DESCRIPTION OF THE RELATED ART

Communication systems, such as wireless communication systems, are available and provide a variety of types of communication. Wireless and wire line systems allow for voice and data communications, for example. Providers of communication services are constantly striving to provide enhanced communication capabilities.

One area in which advancements currently are being made include packet based networks and Internet Protocol networks. With such networks, transcoder free operation can provide higher quality speech with low delay by eliminating the need for tandem coding, for example. In transcoder free operation environments, many speech processing applications should be able to operate in a coded parameter domain. In coded excited linear prediction (CELP) speech coding, which is the most common speech coding paradigm in modern networks, there are several useful coding parameters including fixed and adaptive code book parameters, pitch period, linear predictive coding synthesis filter parameters, for example. Estimating the speech energy of a frame or packet of a communication such as a voice communication provides useful information for such techniques as gain control or echo suppression, for example. It would be useful for develop an efficient method that estimates frame energy from coded parameters without performing a full decoding process to avoid tandem coding and to reduce computational complexity.

### SUMMARY OF THE INVENTION

An exemplary method of processing a communication includes determining an estimated excitation energy component of a subframe of a coded frame. An estimated filter energy component of the subframe is also determined. An estimated energy of the subframe is determined from the estimated excitation energy component and the estimated filter energy component.

The various features and advantages of the disclosed examples will become apparent from the following detailed description. The drawings that accompany the detailed description can be briefly described as follows.

### BRIEF DESCRIPTION OF THE DRAWINGS

FIG. 1 schematically illustrates selected portions of an example communication arrangement.

FIG. 2 is a flowchart diagram summarizing one example approach.

FIG. 3 is a graphical illustration showing a relationship between an estimated subframe energy and actual speech energy of a communication.

FIG. 4 graphically illustrates a response of a linear predictive coding synthesis filter.

FIG. 5 graphically illustrates a relationship between a correlation of an estimated frame energy to actual frame energy and a number of samples used for determining the estimated frame energy.

### DETAILED DESCRIPTION

The following disclosed examples provide an ability to determine an estimated frame energy of a communication without a need to fully decode the communication. The frame energy estimation technique of this description is useful, for example, for estimating speech frame energy, which can be used for such purposes as gain control or echo suppression in a communication system.

FIG. 1 schematically illustrates selected portions of a communication arrangement 20. In one example, the arrangement 20 represents selected portions of a communication device such as a mobile station used for wireless communication. This invention is not limited to any particular type of communication device and the illustration of FIG. 1 is schematic and for discussion purposes.

The example communication arrangement 20 includes a transceiver 22 that is capable of at least receiving a communication from another device. An excitation portion 24 and a linear predictive coding (LPC) synthesis filter portion 26 each provide an output that is used by a frame energy estimator 28 to estimate energy associated with the received communication. In one example, the excitation portion 24 output is based upon an adaptive code book gain gₚ and a fixed code book gain g_{c} as those terms are understood in the context of enhanced variable rate CODEC (EVRC) processing. The excitation portion 24 output is an excitation energy component. The output of the excitation portion 24 is the input signal to the LPC synthesis filter portion 26 in this example. The LPC filter portion 26 output is referred to as a filter energy component in this description.

In one example, the frame energy estimator 28 determines an estimated frame energy of each subframe of coded speech frames of a received speech or voice communication. The frame energy estimator 28 provides the frame energy estimation without requiring that the coded frame be fully decoded. By using coding parameters provided by the LPC synthesis filter portion 26 and the excitation portion 24 and the techniques to be described below, the frame energy estimator 28 provides a useful estimation of the frame energy of a received communication such as speech or voice communications.

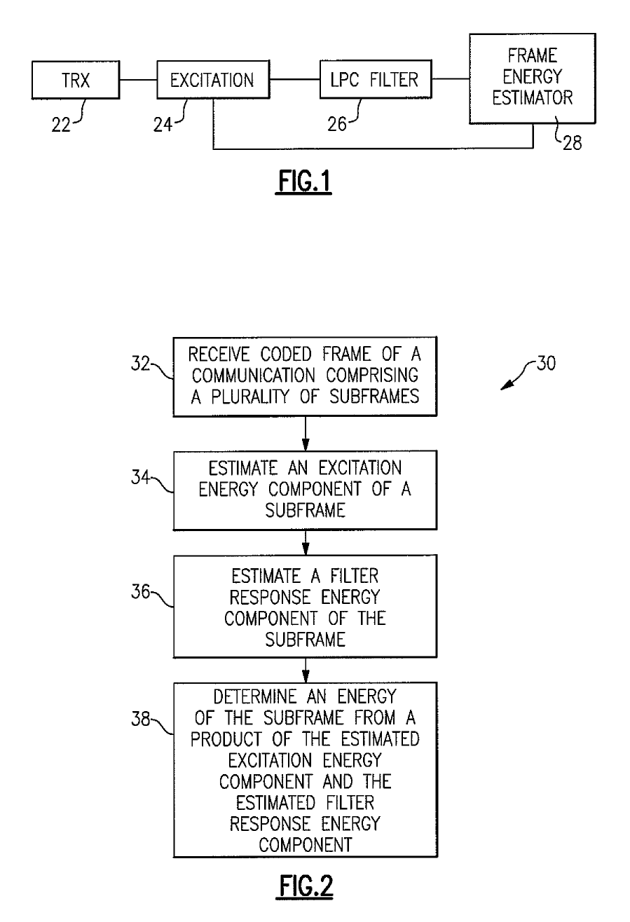

FIG. 2 includes a flowchart diagram 30 that summarizes one example approach. At 32, a coded frame of a communication is received. The received coded frame comprises a plurality of subframes. An excitation energy component of a subframe is estimated at 34. The step at 36 comprises determining an estimated filter energy component of the subframe. At 38, an energy of the subframe is determined from a product of the estimated excitation energy component and the estimated filter energy component. The determined energy of the subframe and the estimated energy components are obtained in one example without needing to fully decode the coded communication (e.g., coded frames of a voice communication).

The product of the estimated excitation energy component and the estimated filter energy component provide a useful estimate of the frame energy and can be described by the following equation:

P(m)˜λₑ(m)λₕ(m) (Eq. 1)

where λₑ(m) and λₕ(m) are the estimated excitation energy component and estimated filter energy component, respectively. This relationship provides an estimate of the frame energy P(m) by using coded parameters without performing a full decoding process.

Before considering example ways of using the above relationship, it is useful to consider how frame energy can be determined if a full decoding process were used. A decoded speech signal, for example, of an m-th frame can be represented as

x(m;n)=h(m;n)*e_{T}(m;n) (Eq. 2)

where h(m;n) is the filter of a LPC synthesis filter and _{eT}(m;n) is the total excitation signal.

The actual energy of a CELP-coded frame can be described as follows:

$$\begin{matrix}P ( m ) = {\sum }_{n} {x}^{2} ( m ; n ) \\ = {\sum }_{n} {[ h ( m ; n ) * {e}_{T} ( m ; n ) ]}^{2} \\ = {\sum }_{k} {[ H ( m ; k ) {E}_{T} ( m ; k ) ]}^{2}\end{matrix} \qquad ( Eq . 3 )$$

where H(m;k) and E_{T}(m;k) are FFT-representations of h(m;n) and e_{T}(m;n), respectively.

One drawback associated with calculating P(m) is that it is necessary to perform a full CELP decoding process. This includes deriving the excitation signal and LPC synthesis filter described by the following:

$$H ( z ) = \frac{1}{A ( z )} = \frac{1}{1 - {\sum }_{k = 1}^{10} {a}_{k} {z}^{- k}} \qquad ( Eq . 4 )$$

Additionally, the excitation signal must be filtered through H(z).

Using the relationship P(m)˜λₑ(m)λₕ(m) allows for estimating the frame energy without requiring a full decoding process.

Estimating the excitation energy component of a subframe in one example includes utilizing two code book parameters available from an EVRC. In one example, the EVRC finds an adaptive code book gain gₚ and a fixed code book gain g_{c} from a received subframe in a known manner. In one example, these are used according to the following relationship:

e_{T}(n)=gₚe(n)=g_{c}c(n) (Eq. 5)

where e(n) is the adaptive code book contribution and c(n) is the fixed code book contribution. Accordingly, the total excitation can be approximated as

$$\begin{matrix}{e}_{T} ( n ) \approx {g}_{p} e ( n - τ ) + {g}_{c} c ( n ) \\ \approx {g}_{p} {e}_{T} ( n - τ ) + {g}_{c} c ( n )\end{matrix} \qquad ( Eq . 6 )$$

where τ is the pitch period of the communication of interest. The subframe energy of excitation can be represented as

$$\begin{matrix}{\sum }_{n} {e}_{T}^{2} ( n ) \approx {\sum }_{n} {[ {g}_{p} {e}_{T} ( n - τ ) = {g}_{c} c ( n ) ]}^{2} \\ = {g}_{p}^{2} {\sum }_{n} {e}_{T}^{2} ( n - τ ) = {g}_{c}^{2} {\sum }_{n} {c}^{2} ( n ) + \\ 2 {g}_{p} {g}_{c} {\sum }_{n} {e}_{T} ( n - τ ) c ( n )\end{matrix} \qquad ( Eq . 7 )$$

The summations in the above-equation in one example are taken for L samples.

One example includes approximating the energy of the adaptive code book contribution e(n) based upon a previous subframe energy. Such an approximation can be described as follows:

$${\sum }_{n} {e}_{T}^{2} ( n - τ ) \approx {λ}_{e} ( m - 1 ) \qquad ( Eq . 8 )$$

Substituting this into equation 7 yields

$${λ}_{e} ( m ) \approx {g}_{p}^{2} ( m ) λ ( m - 1 ) + C {g}_{c}^{2} ( m ) \qquad ( Eq . 9 )$$

in which λ(m−1) is the previous subframe energy and C is a constant energy term used for the codebook contribution c²(n). In one example, eight samples of c²(n) in a subframe have an amplitude +1 or −1 and the rest have a zero value in EVRC so that the value of C is set to 8.

One example use of the disclosed techniques is for estimating speech energy of speech or voice communications. FIG. 3 includes a graphical plot 40 showing actual speech energy at 42 and an estimated excitation subframe energy component obtained using the relationship of equation 9. As can be appreciated from FIG. 3, there is significant correspondence between the estimated excitation energy component and the actual speech energy when using the approach of equation 9.

Another example includes utilizing at least two previous subframes to approximate the energy of the adaptive code book contribution. Recognizing that the adaptive code book contribution is at least somewhat periodic allows for selecting at least two previous subframes from a portion of the communication that is approximately a pitch period away from the subframe of interest so that the selected previous subframes are from a corresponding previous portion of the communication. One example includes using two consecutive previous subframes such that the adaptive code book contribution is considered to be approximately the interpolation of two consecutive previous subframes as follows:

$${\sum }_{n} {e}_{T}^{2} ( n - τ ) = {ωλ}_{e} ( m - i ) + ( 1 - ω ) {λ}_{e} ( m - i + 1 ) \qquad ( Eq . 10 )$$

where i is selected according to the pitch period of the communication. Using this estimation technique yields the following estimation for the excitation energy component:

$${λ}_{e} ( m ) \approx {g}_{p}^{2} ( m ) [ {ωλ}_{e} ( m - i ) + ( 1 - ω ) {λ}_{e} ( m - i + 1 ) ] + C {g}_{c}^{2} ( m ) \qquad ( Eq . 11 )$$

Using this latter approach instead of that associated with equation 9 yields results that are at least as good as those shown in FIG. 3 for many situations. In some examples, the approach associated with equation 11 provides more accurate estimations of the excitation energy component compared to estimations obtained using equation 9.

Estimating the filter energy component in one example includes using a parameter of an LPC synthesis filter. In general, the energy of an LPC synthesis filter at an m-th subframe can be represented as

$${\sum }_{k} {\vert H ( m ; n ) \vert}^{2} = {\sum }_{n}^{∞} {h}^{2} ( m ; n ) \qquad ( Eq . 12 )$$

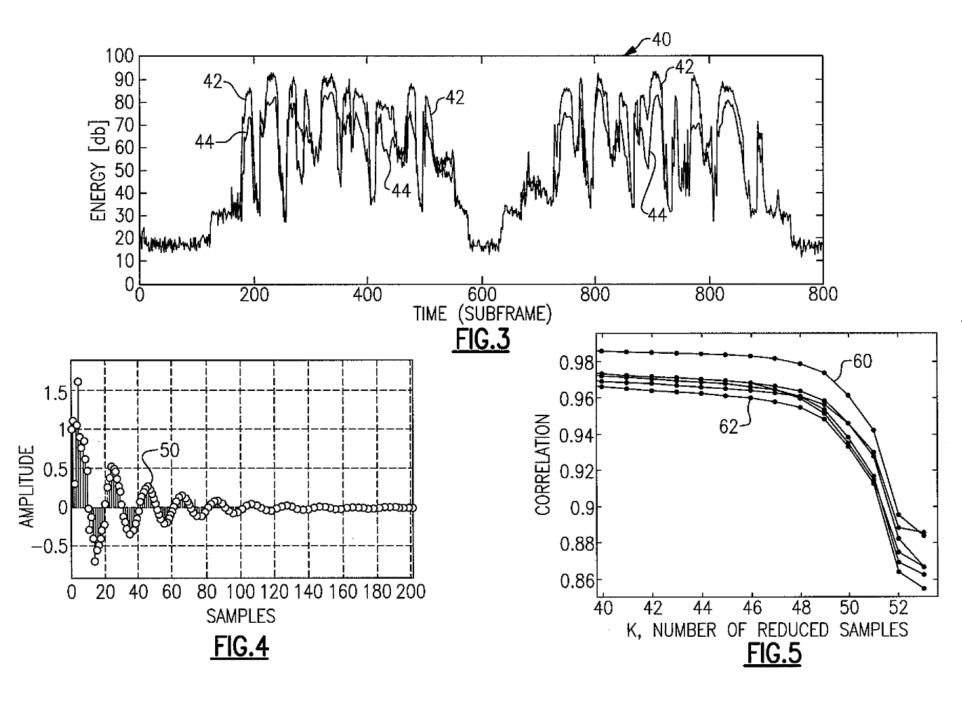

Of course, summing an infinite number of samples is not practical and this example includes recognizing that an LPC synthesis filter is a minimum phase stable system and it is reasonable to assume that most of the signal energy is concentrated in the initial part of the filter response. FIG. 4 graphically illustrates an example impulse response 50 of an LPC filter. As can be appreciated from FIG. 4, the most significant amplitudes of the impulse response 50 occur at the beginning (e.g., toward the left in the drawing) of the impulse response.

In one example, the LPC synthesis filter energy component is estimated using a reduced number of samples in the following relationship

$${λ}_{h} ( m ) \approx {\sum }_{n = 0}^{L - 1 - K} {h}^{2} ( m ; n ) \qquad ( Eq . 13 )$$

where K>0 is the number of reduced samples (e.g., how many samples are discarded or ignored) used for determining the filter energy. It is possible to obtain a sufficiently accurate correlation between the determined estimated LPC synthesis filter energy component using a reduced number of samples compared to using equation 12 provided that a sufficient number of samples are utilized.

FIG. 5 graphically illustrates a correlation between the estimated and actual energies for a plurality of different communications (e.g., different types of speech, voice communications or other audible communications). The curve 60 and the curve 62 each corresponds to a different communication. In one example, the curves in FIG. 5 each corresponds to a different type of voice communication (e.g., different content). As can be appreciated from FIG. 5, as the number of samples that are discarded increases, the correlation drops off. In one example, it has been empirically determined that utilizing up to the first ten samples of an LPC synthesis filter response provides sufficient correlation and adequate information for estimating the filter response energy component. One particular example achieves effective results by using only the first six or seven samples of the LPC synthesis filter response. Given this description, those skilled in the art will be able to determine how many samples will be useful or necessary for their particular situation.

Having determined the estimated excitation component using one of equations 9 or 11 and having determined the estimated filter energy component using equation 13, the estimated frame energy k(m) of the subframe of interest is determined using the following relationship:

$$\begin{matrix}λ ( m ) = {λ}_{e} ( m ) {λ}_{h} ( m ) \\ = [ {g}_{p}^{2} ( m ) λ ( m - 1 ) + C {g}_{c}^{2} ( m ) ]\end{matrix} \\ {\sum }_{n = 0}^{L - 1 - K} {h}^{2} ( m ; n ) \qquad ( Eq . 14 )$$

Using the above techniques allows for estimating the frame energy of a communication such as speech or a voice communication without having to fully decode the communication. Such estimation techniques reduce computational complexity and provide useful energy estimates more quickly, both of which facilitate enhanced voice communication capabilities.

The determined estimated frame energy is used in some examples for controlling a subsequent communication. In one example, the estimated frame energy is used for gain control. In another example, the estimated frame energy is used for echo suppression.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of processing a communication, comprising the steps of:
determining an estimated excitation energy component of a subframe of a coded frame;
determining an estimated filter energy component of the subframe; and
determining an estimated energy of the subframe from the estimated excitation energy component and the estimated filter energy component.

2. The method of claim 1, comprising
determining the estimated energy from a product of the estimated excitation energy component and the estimated filter energy component.

3. The method of claim 1, comprising
determining an adaptive contribution to the excitation energy component;
determining a fixed contribution to the excitation energy component; and
determining the estimated excitation energy component based upon the determined adaptive and fixed contributions.

4. The method of claim 3, wherein determining the adaptive contribution comprises
estimating an adaptive contribution of the subframe based upon energy of at least one previous subframe of the coded frame; and
determining a sum of a plurality of estimated subframe adaptive contributions of the coded frame.

5. The method of claim 4, comprising
estimating the adaptive contribution of the subframe based upon an immediately adjacent previous subframe.

6. The method of claim 5, comprising
determining the adaptive contribution of the subframe to be the same as the immediately adjacent previous subframe.

7. The method of claim 4, comprising
estimating the adaptive contribution of the subframe based upon at least two consecutive previous subframe energies.

8. The method of claim 7, comprising
selecting the at least two consecutive previous subframes based upon a pitch period of the communication.

9. The method of claim 8, wherein the communication is at least partially periodic and the pitch period indicates corresponding portions of the communication at time intervals corresponding to the pitch period and comprising using the pitch period to select the at least two consecutive previous subframes from a previous portion of the communication that corresponds to the subframe.

10. The method of claim 3, comprising
determining an adaptive codebook gain associated with the adaptive contribution using an enhanced variable rate CODEC;
determining a fixed codebook gain associated with the fixed contribution using the enhanced variable rate CODEC; and
determining the estimated excitation energy component based upon the determined adaptive codebook gain and the fixed codebook gain.

11. The method of claim 1, wherein the estimated filter energy component is associated with a linear predictive coding synthesis filter.

12. The method of claim 11, comprising
selecting only an initial portion of a response of the filter for determining the estimated filter energy component.

13. The method of claim 12, comprising
selecting less than ten samples of the response of the filter and
using the selected samples for determining the estimated filter energy component.

14. The method of claim 1, wherein the coded frame is part of a voice communication.

15. The method of claim 1, comprising
determining the estimated frame energy without fully decoding the subframe.
